(19) United States
(12) Patent Application Publication
(10) Pub. No.: US 2026/0333479 A1
(43) Pub. Date: Oct. 22, 2026

(54) Concurrent Wireless Protocol Negotiation and Audio Device Boot Sequence

(71) Applicant: Google LLC, Mountain View, CA (US)

(72) Inventors: Yao Ding, San Jose, CA (US); Qi Qi, San Jose, CA (US)

(73) Assignee: Google LLC, Mountain View, CA (US)

(21) Appl. No.: 19/689,046

(22) Filed: May 27, 2026

(51) Int. Cl. H04W 76/14; H04W 4/80; H04W 12/041; H04W 52/02

(52) U.S. Cl. CPC H04W 76/14; H04W 4/80; H04W 12/041; H04W 52/0235

(57) ABSTRACT

Wearable audio systems involve initializing hardware components and negotiating wireless connections, which introduces latency during connection establishment. An enclosure device detects a trigger event and transmits a wake-up signal to initiate a boot sequence of an audio device. Concurrently with the boot sequence of the audio device, the enclosure device transmits an identifier associated with the audio device to an electronic device and negotiates a connection state on behalf of the audio device. The enclosure device transfers connection state data to the audio device. The audio device establishes a wireless connection with the electronic device based on the connection state data and a connection request from the electronic device. Executing the connection state negotiation concurrently with the boot sequence facilitates parallel execution and mitigates connection latency.

### SUMMARY

This document describes techniques and apparatuses, implemented on mobile devices (e.g., audio device charging cases and wireless earbuds), directed at concurrent wireless protocol negotiation and audio device boot sequencing. These techniques mitigate connection latency by enabling a connection state negotiation to occur concurrently with a hardware boot sequence of an audio device, thereby facilitating parallel execution and expediting wireless connection establishment.

In general, a first aspect of the present disclosure relates to a method for concurrent wireless protocol negotiation and audio device boot sequence. The method is performed by an enclosure device of an audio device, the enclosure device having a lid and a sensor. The method includes detecting, via the sensor, a trigger event, the trigger event including an opening of the lid. The method further includes transmitting, from the enclosure device to the audio device and in response to the trigger event, a wake-up signal configured to initiate a boot sequence of the audio device. The method also includes negotiating, by the enclosure device with an electronic device, a connection state on behalf of the audio device. Further, the method includes transferring, from the enclosure device to the audio device, connection state data associated with the negotiated connection state, the connection state data enabling the audio device to establish a wireless connection with the electronic device.

This document also describes computer-readable media having instructions for performing the above-summarized method and other methods set forth herein, as well as systems and means for performing these methods.

This Summary is provided to introduce simplified concepts for Concurrent Wireless Protocol Negotiation and Audio Device Boot Sequence, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of concurrent wireless protocol negotiation and audio device boot sequence are described throughout the disclosure, with reference to the drawings. The use of the same reference numbers in different instances in the detailed description and the drawings indicates same or similar elements:

FIG. 1 illustrates an example environment for concurrent wireless protocol negotiation and audio device boot sequence;

FIG. 2 illustrates an example system architecture for concurrent wireless protocol negotiation and audio device boot sequence;

FIG. 3 illustrates an example sequence of operations for concurrent wireless protocol negotiation and audio device boot sequence;

FIG. 4 illustrates an example method performed by an enclosure device for concurrent wireless protocol negotiation and audio device boot sequence;

FIG. 5 illustrates an example method performed by an audio device for concurrent wireless protocol negotiation and audio device boot sequence.

### DETAILED DESCRIPTION

In everyday scenarios, users frequently interact with wearable audio systems, such as wireless earbuds stored within an enclosure device. A typical interaction begins when a user accesses the enclosure device to retrieve the audio devices for use with a companion electronic device, such as a smartphone, smartwatch, or tablet. To conserve battery resources during periods of non-use, the audio devices may reside in a low-power or powered-off state while stored within the enclosure device. The audio devices generally undergo a hardware and software boot sequence before they can establish a wireless connection to stream media or handle communications.

To facilitate a responsive user experience, the enclosure device can serve as an active participant in establishing a wireless link between the audio devices and the electronic device. For example, a user interaction, such as opening a lid of the enclosure device, can be detected by a sensor as a trigger event. In response to this trigger event, the enclosure device may transmit a wake-up signal to the dormant audio devices. This signal initiates a boot sequence for the audio devices, which may involve ramping up power rails and transferring execution code into random-access memory (RAM) to prepare the internal processors of the audio devices for full operation.

Rather than waiting for the audio devices to fully power on and independently initialize their own communication interfaces, the enclosure device can concurrently negotiate a connection state with the electronic device on behalf of the audio devices, which may occur concurrently, or at least partially concurrently, with the boot sequence. The enclosure device may transmit a communication containing an identifier, such as a Media Access Control (MAC) address, associated with the audio devices. By communicating with the electronic device while the audio devices are still executing their physical boot sequence, the enclosure device can establish the security credentials and connection parameters, such as generating session keys, in parallel with the hardware initialization.

Once the connection state is negotiated, the enclosure device transfers connection state data to the audio devices. This transfer may occur via physical electrical contacts within the enclosure device or through a localized wireless communication link. Upon receiving the connection state data and advancing their boot sequence, the audio devices can detect a connection request from the electronic device. The audio devices can then assume the wireless connection based on the pre-negotiated state data, and notify the enclosure device, which may subsequently disable its own transceiver to prevent network addressing conflicts.

Implementing a concurrent protocol negotiation and hardware boot sequence provides several technical effects and operational advantages. By shifting the initial wireless discovery and cryptographic negotiation to the enclosure device, overall connection latency can be mitigated. The parallel execution functionally masks the hardware boot time of the audio devices behind the wireless protocol negotiation, enabling the audio devices to establish an active media or communication link rapidly upon waking. Further, this configuration allows the processors of the audio devices to remain in a deep energy-saving state until explicitly needed, promoting power efficiency.

### Example Environment

The following discussion describes an operating environment, techniques that may be employed in the operating environment, and various devices or systems in which components of the operating environment may be embodied. In the context of the present disclosure, reference is made to the operating environment by way of example only.

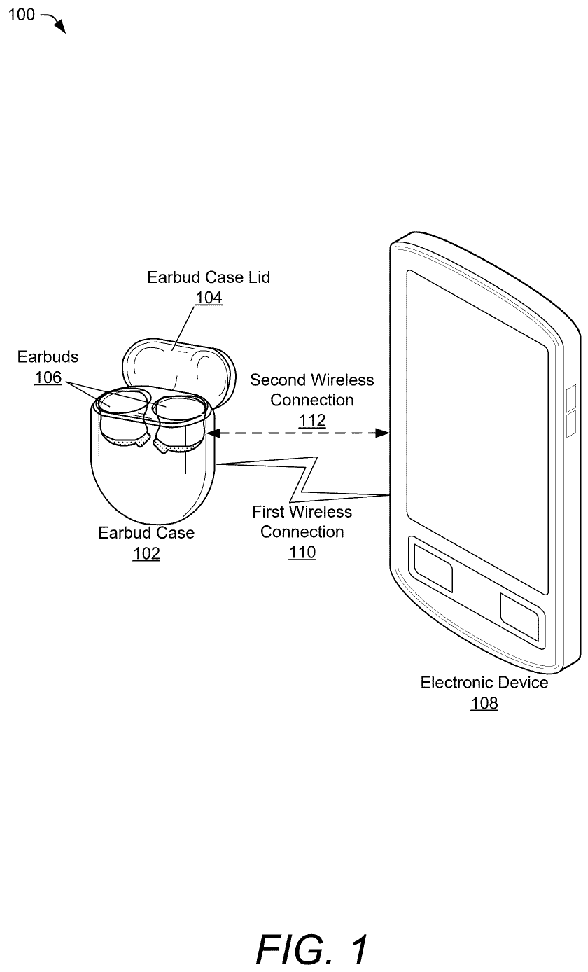

FIG. 1 illustrates an example environment 100 for concurrent wireless protocol negotiation and audio device boot sequence. The environment 100 represents a physical and operational setting in which a user interacts with portable audio hardware and a companion media host. In various implementations, the environment 100 can encompass a local personal area network setting, such as a space around a user in a home, an office, a vehicle, or a public transit space. The environment 100 supports parallel hardware initialization and wireless communication protocols to transition devices from a dormant state to an active media streaming state.

The environment 100 includes an earbud case 102. The earbud case 102 operates as an accessory device (e.g., a charging case) or an enclosure device that stores, protects, and charges companion audio components. In some implementations, the earbud case 102 includes internal processors, memory, and communication transceivers that remain active in a low-power mode even when not actively in use. The earbud case 102 features an earbud case lid 104. The earbud case lid 104 represents a movable physical barrier that encloses an internal cavity of the earbud case 102. The earbud case lid 104 transitions between a closed position and an open position. The earbud case 102 detects the movement or state of the earbud case lid 104 using internal sensors, such as a hall effect sensor, an optical sensor, a mechanical switch, or an electrical switch. The earbud case 102 interprets the opening of the earbud case lid 104 as a trigger event indicating that a user intends to utilize the enclosed audio components.

The environment 100 further includes earbuds 106. The earbuds 106 reside within the internal cavity of the earbud case 102 and remain physically protected by the earbud case lid 104 when in the closed position. The earbuds 106 represent wearable audio playback devices, which may include true wireless stereo earbuds, hearing aids, communication earpieces, or augmented reality audio wearables. To conserve internal battery resources, the earbuds 106 typically remain in a powered-down or deep-sleep state while stored inside the earbud case 102. Upon receiving a physical or electrical wake-up signal from the earbud case 102, the earbuds 106 initiate a physical boot sequence. This boot sequence may involve ramping up internal power rails, performing initial hardware checks, and copying execution code from a flash memory component into a random-access memory component for active execution.

The environment 100 also includes an electronic device 108. The electronic device 108 serves as a host system that provides audio data, media streams, or communication channels. Examples of the electronic device 108 include a smartphone, a tablet computer, a smartwatch, a laptop computer, a desktop workstation, a smart home hub, or a vehicle infotainment system. The electronic device 108 includes multiple wireless transceivers capable of listening for incoming connection requests across various frequencies and protocols, including low-energy discovery channels and higher-bandwidth data channels, supporting Bluetooth® Classic and Bluetooth® Low Energy (BLE).

The environment 100 includes a first wireless connection 110. The earbud case 102 establishes the first wireless connection 110 with the electronic device 108. The first wireless connection 110 represents an initial communication link that the earbud case 102 utilizes for discovery, identification, and security negotiation. In some implementations, the first wireless connection 110 utilizes a low-energy or low-bandwidth protocol, such as a Bluetooth Low Energy protocol, a near-field communication link, or a proprietary low-power radio frequency link. The earbud case 102 utilizes the first wireless connection 110 to broadcast an advertising packet or a similar initial communication to the electronic device 108. The earbud case 102 acts as a proxy via the first wireless connection 110, transmitting identifiers associated with the earbuds 106 to negotiate a connection state with the electronic device 108 before the earbuds 106 complete their own boot sequence.

The environment 100 includes a second wireless connection 112. The earbuds 106 ultimately establish the second wireless connection 112 with the electronic device 108. The second wireless connection 112 represents a persistent, active data link capable of streaming high-fidelity audio or supporting bi-directional voice calls. For example, the second wireless connection 112 may operate over a Bluetooth Classic protocol, a Wi-Fi Direct protocol, or an ultra-wideband communication protocol. The earbuds 106 establish the second wireless connection 112 by using the connection state data already negotiated by the earbud case 102 over the first wireless connection 110.

In an example operational sequence, the earbud case 102 detects an opening of the earbud case lid 104. In response to detecting this physical transition, the earbud case 102 transmits a wake-up signal to the earbuds 106 via internal physical contacts or a localized inductive pulse. The earbuds 106 begin executing a hardware boot sequence in response to the wake-up signal. Concurrently, while the earbuds 106 execute the boot sequence, the earbud case 102 activates an internal transceiver to broadcast an identifier associated with the earbuds 106 over the first wireless connection 110 to the electronic device 108.

Continuing the operational sequence, the electronic device 108 detects the broadcast over the first wireless connection 110 and negotiates a connection state, such as exchanging cryptographic session keys, with the earbud case 102. The earbud case 102 subsequently transfers the connection state data to the booting earbuds 106. The earbuds 106 finish copying their execution code into active memory, initialize their own transceivers, and detect a targeted connection request from the electronic device 108. The earbuds 106 utilize the connection state data provided by the earbud case 102 to assume the session and establish the second wireless connection 112 with the electronic device 108 for media streaming.

### Example Devices and Systems

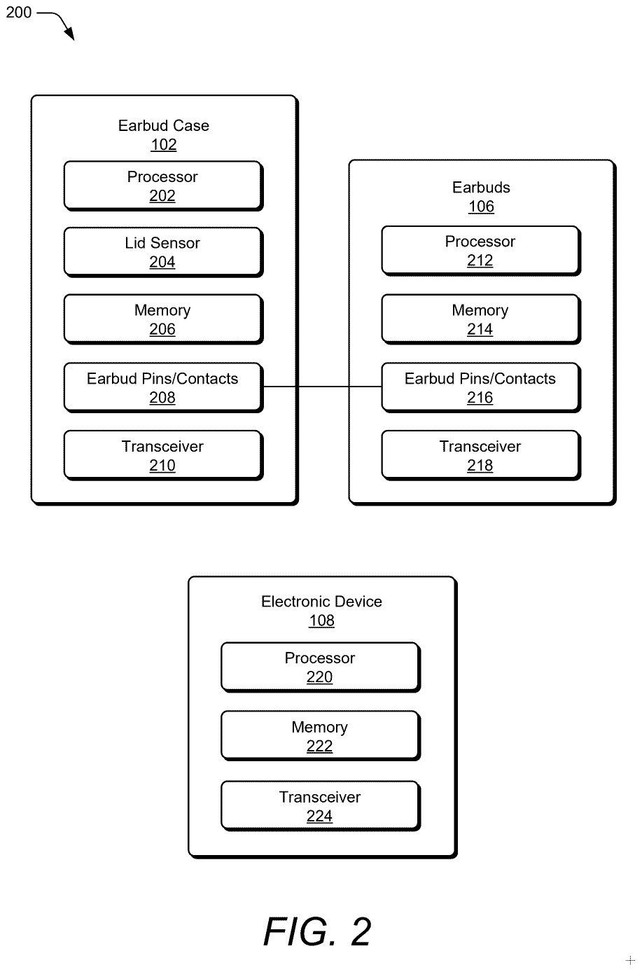

FIG. 2 illustrates a block diagram of internal components 200 for an example system architecture supporting concurrent wireless protocol negotiation and audio device boot sequence. The block diagram of internal components 200 outlines hardware modules, processors, and communication interfaces. In various implementations, the block diagram of internal components 200 portrays the physical and logical boundaries of the components participating in the boot and negotiation sequence.

The block diagram of internal components 200 includes an earbud case 102. The earbud case 102 houses several components to manage physical triggers, maintain power-efficient states, and broker initial communications. The earbud case 102 includes a processor 202. The processor 202 can operate as a microcontroller unit configured to execute instructions in a low-power state, allowing the earbud case 102 to monitor for user interactions. The earbud case 102 includes a lid sensor 204 communicatively coupled to the processor 202. The lid sensor 204 represents a hardware component, such as a magnetic hall effect sensor, an optical sensor, or a mechanical or electrical switch, configured to detect physical transitions of an enclosure barrier. The earbud case 102 further includes a memory 206 accessible by the processor 202. In some cases, the memory 206 stores executable instructions directly accessible by the processor 202 in an execute-in-place mode without copying the instructions to a separate random-access memory. The earbud case 102 features earbud pins/contacts 208. The earbud pins/contacts 208 provide a physical, electrical interface to transmit power and data signals to housed devices. Additionally, the earbud case 102 includes a transceiver 210. The transceiver 210 comprises radio frequency hardware, such as a short range radio frequency transceiver or a low-energy wireless protocol radio, capable of broadcasting and receiving wireless communication signals.

The block diagram of internal components 200 includes earbuds 106. The earbuds 106 contain computing and communication hardware to process audio data streams. The earbuds 106 include a processor 212. The processor 212 can comprise a system-on-chip that manages digital signal processing, audio decoding, and protocol stacks. The earbuds 106 include a memory 214. The memory 214 can comprise a combination of non-volatile flash storage and internal random-access memory. To interface with external hardware, the earbuds 106 include earbud pins/contacts 216. The earbud pins/contacts 216 physically align and electrically couple with the earbud pins/contacts 208 of the earbud case 102 to form a wired communication and charging link. The earbuds 106 also include a transceiver 218. The transceiver 218 supports high-bandwidth wireless protocols for media streaming and voice communication.

The block diagram of internal components 200 includes an electronic device 108. The electronic device 108 acts as a central host device that streams audio or handles communication channels. The electronic device 108 includes a processor 220 configured to manage operating systems, user interfaces, and audio applications. The electronic device 108 includes a memory 222 to store user profiles, cryptographic keys, device registries, and media files. The electronic device 108 includes a transceiver 224 communicatively coupled to the processor 220. The transceiver 224 operates as a multi-modal radio component capable of scanning for low-energy broadcasts and establishing active data connections over multiple wireless protocols.

In an example operational sequence, the components illustrated in the block diagram of internal components 200 interact to accelerate device readiness. The lid sensor 204 detects a physical event, such as a user opening the earbud case 102, and generates an interrupt signal. The processor 202 receives the interrupt signal and transitions from a sleep state to an active state. Operating on instructions from the memory 206, the processor 202 generates a wake-up signal. The processor 202 transmits this wake-up signal through the earbud pins/contacts 208 to the earbud pins/contacts 216. Upon receiving the wake-up signal via the earbud pins/contacts 216, the processor 212 initiates a hardware boot sequence. This boot sequence involves drawing power, activating voltage rails, and copying firmware within the memory 214 to prepare the transceiver 218 for operation.

Concurrently with the boot sequence executing on the processor 212 and the memory 214, the processor 202 of the earbud case 102 negotiates a connection state on behalf of the earbuds 106. The processor 202 directs the transceiver 210 to broadcast a communication, such as an advertising packet, containing an identifier associated with the earbuds 106. The transceiver 224 of the electronic device 108 receives the broadcast. The processor 220 references cryptographic credentials stored in the memory 222 to authenticate the communication. The processor 202 and the processor 220 utilize the transceiver 210 and the transceiver 224 to exchange protocol data and negotiate session keys, thereby forming a secure connection state while the processor 212 physically powers up the earbuds 106.

Following the negotiation, the processor 202 transfers connection state data to the earbuds 106. The processor 202 routes the negotiated session keys through the earbud pins/contacts 208 and the corresponding earbud pins/contacts 216 to the processor 212. After transferring the connection state data, the processor 202 may disable the transceiver 210 to prevent network addressing conflicts. As the processor 212 finishes the boot sequence, the processor 212 activates the transceiver 218. Because the processor 220 previously negotiated the connection state with proxy components, the processor 220 directs the transceiver 224 to initiate an active connection request targeting the earbuds 106. The transceiver 218 detects the active connection request, and the processor 212 uses the connection state data transferred into the memory 214 to accept the request. This interaction establishes a persistent wireless media link between the transceiver 218 and the transceiver 224.

During the concurrent boot and negotiation sequence, the enclosure device may leverage a Generic Attribute Profile (GATT) over a Bluetooth® Low Energy link to prepare the electronic device for media routing. While the audio device continues its physical hardware initialization, the enclosure device transmits a GATT communication to the electronic device indicating that the audio system is present and prepared to receive an audio stream. This proactive signaling prompts the electronic device to begin resolving audio profiles, enabling a media handoff when the high-bandwidth transceiver of the audio device finishes booting and comes online.

In some implementations, the electronic device facilitates the authentication process by utilizing a Bloom filter synced against account credentials of a user, such as Google Account Keys. When the enclosure device transmits the first communication over the low-energy wireless connection, the electronic device references this Bloom filter to verify the identity of the audio device. This verification mechanism allows the system to bypass manual authentication or personal identification number (PIN) exchanges. By validating the synced keys, the electronic device advances the connection state negotiation while the audio device completes its boot sequence.

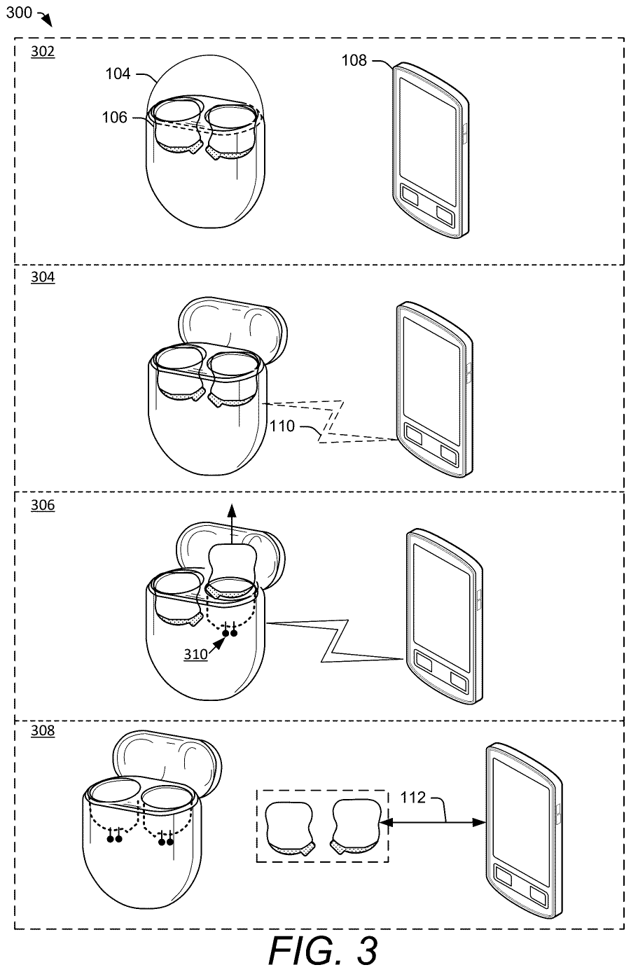

FIG. 3 illustrates an example sequence diagram showing connection progression 300 for concurrent wireless protocol negotiation and audio device boot sequence. The sequence diagram showing connection progression 300 depicts a progression of physical and communicative states that an enclosure device traverses to establish an active media link between portable audio devices and a host. The sequence diagram showing connection progression 300 illustrates interactions involving an earbud case lid 104, earbuds 106, and an electronic device 108. An enclosure device coordinates a first wireless connection 110 and a second wireless connection 112 to prepare the electronic device 108 for an incoming connection while simultaneously initializing internal hardware of the earbuds 106.

At 302, an enclosure device maintains a case closed state. In the case closed state, the enclosure device keeps the earbud case lid 104 in a secure, closed position over an internal cavity. The enclosure device stores the earbuds 106 within this cavity. During this state, the earbuds 106 remain in a deep sleep or powered-down condition to prevent battery drainage. The electronic device 108 operates nearby without an active audio streaming connection to the earbuds 106. For example, a user carries the enclosure device in a pocket while the electronic device 108 rests in another pocket, during which the earbuds 106 draw low current and the electronic device 108 periodically scans for nearby communication broadcasts.

At 304, the enclosure device transitions to a case open/initial connection state. The enclosure device detects a physical manipulation of the earbud case lid 104 into an open position. In response to detecting the open position of the earbud case lid 104, the enclosure device activates an internal low-power transceiver and establishes the first wireless connection 110 with the electronic device 108. The enclosure device utilizes the first wireless connection 110 to transmit a communication, such as an advertising packet, containing an identifier associated with the earbuds 106. The electronic device 108 receives this communication via the first wireless connection 110 and negotiates a connection state directly with the enclosure device on behalf of the earbuds 106. For example, upon a user opening the earbud case lid 104, the enclosure device broadcasts proxy credentials over the first wireless connection 110, prompting the electronic device 108 to begin exchanging cryptographic keys before the earbuds 106 fully power on.

At 306, the enclosure device executes an internal hardware wake-up state. The enclosure device generates a physical or electrical wake-up signal concurrently with the negotiations taking place over the first wireless connection 110. The enclosure device transmits this wake-up signal to the earbuds 106 through a pogo pins/contacts interaction 310. The pogo pins/contacts interaction 310 represents a localized, wired electrical connection between a housing of the enclosure device and the earbuds 106. Upon receiving the wake-up signal via the pogo pins/contacts interaction 310, the earbuds 106 begin an internal boot sequence. Once the enclosure device completes the connection state negotiation with the electronic device 108, the enclosure device transfers the resulting connection state data to the earbuds 106 via the pogo pins/contacts interaction 310. For example, as a user begins to physically pull the earbuds 106 out of the enclosure device, the enclosure device passes negotiated session keys through the pogo pins/contacts interaction 310, enabling the earbuds 106 to load the keys into active memory as their internal voltage rails ramp up.

At 308, the earbuds 106 operate in an earbuds removed/active streaming state. The earbuds 106 finish their internal boot sequence and activate their own internal wireless transceivers after being removed from the enclosure device. The electronic device 108 transmits connection requests targeted at the earbuds 106 based on the previous negotiations with the enclosure device. The earbuds 106 detect these requests and use pre-negotiated connection state data to accept the connection, thereby establishing the second wireless connection 112 with the electronic device 108. The earbuds 106 utilize the second wireless connection 112 to receive active audio streams or handle bi-directional voice communications. For example, by the time the user places the earbuds 106 in their ears, the earbuds 106 assume a pre-negotiated link to form the second wireless connection 112, allowing the electronic device 108 to rapidly route media playback audio to the earbuds 106 without standard pairing delays.

### Example Methods

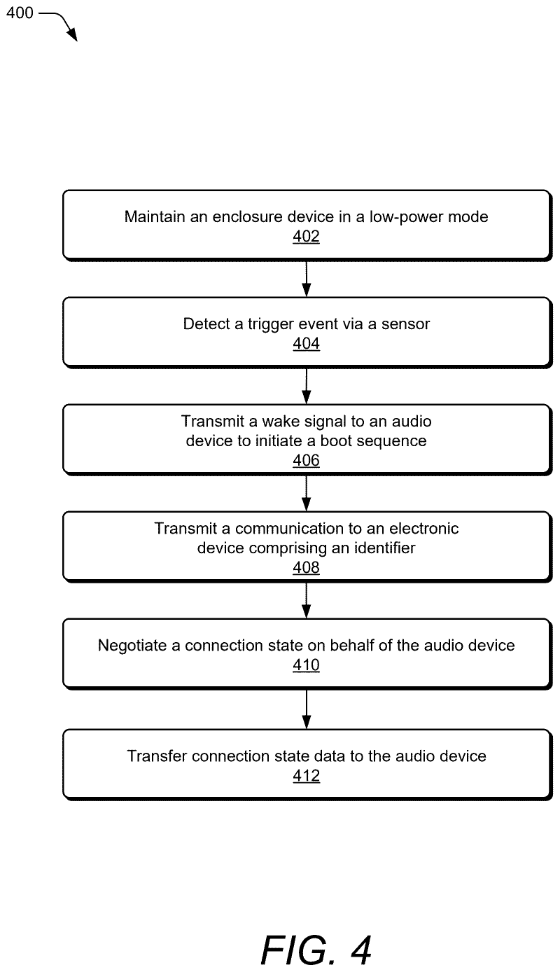

FIG. 4 illustrates an example method 400 for concurrent wireless protocol negotiation and audio device boot sequence in accordance with one or more aspects. Operations of the method 400 are implemented by or with earbud case 102.

Example method 400 is described with reference to FIG. 4 in accordance with one or more aspects of concurrent wireless protocol negotiation and audio device boot sequence. Generally, the method 400 illustrates sets of operations (or acts) performed in, but not necessarily limited to, the order or combinations in which the operations are shown herein. Further, any of one or more of the operations may be repeated, combined, reorganized, omitted, or linked to provide a variety of additional and/or alternate methods. In portions of the following discussion, reference may be made to the entities of FIG. 1-3, reference to which is made for example only. The systems and methods described in this disclosure are not limited to embodiment or performance by one entity or multiple entities operating in relation to concurrent wireless protocol negotiation and audio device boot sequence.

FIG. 4 illustrates an example method flowchart 400 performed by an enclosure device for concurrent wireless protocol negotiation and audio device boot sequence. The method flowchart 400 represents a sequence of operations that an enclosure device executes to serve as a communicative proxy. By executing the operations outlined in the method flowchart 400, the enclosure device establishes a connection state with a host system in parallel with the hardware initialization of a companion device, thereby mitigating overall user-perceived connection latency.

At 402, a processor of the enclosure device operates in a low-power mode. In various implementations, the enclosure device operates as the accessory device, configuring internal computing processors and memory components to operate in a reduced power state to conserve electrical energy during periods of inactivity. The enclosure device suspends high-power digital processing tasks and disables wireless radio transmissions while keeping basic monitoring circuits active. For example, a user places the enclosure device on a table and leaves it untouched overnight, during which the enclosure device operates in the low-power mode, drawing low current from an internal battery to maintain readiness without performing active computations.

At 404, the enclosure device detects a trigger event via a sensor. The enclosure device continuously monitors the sensor, which may comprise a mechanical or electrical switch, a magnetic hall effect sensor, or an optical sensor, for state changes that indicate a user intends to operate the system. Upon registering a state change from the sensor, the enclosure device generates a hardware interrupt that wakes internal processors from the low-power mode. For example, a user physically flips open a lid of the enclosure device, moving a magnet away from the sensor, which the enclosure device detects as the trigger event.

At 406, the enclosure device transmits a wake-up signal to an audio device to initiate a boot sequence. The enclosure device sends the wake-up signal using a direct electrical connection, such as physical interface pins, or via a localized inductive pulse. The wake-up signal provides a hardware stimulus that prompts the audio device to exit a deep sleep state, ramp up internal voltage regulators, and begin copying executable code from long-term storage into active processing memory to execute the boot sequence. For example, immediately following the detection of the trigger event, the enclosure device routes a voltage pulse to the audio device stored within a housing, causing the audio device to begin the boot sequence.

At 408, the enclosure device transmits a first communication including an identifier to an electronic device. The enclosure device utilizes an internal wireless transceiver to broadcast this communication over a discovery channel concurrently with the audio device executing the boot sequence. The communication encapsulates the identifier, such as a media access control address or a globally unique identifier, that explicitly identifies the audio device rather than identifying the enclosure device, allowing the enclosure device to impersonate the audio device. For example, while the audio device remains busy loading an operating system, the enclosure device transmits a low-energy advertising packet containing the credentials of the audio device to a nearby smartphone acting as the electronic device.

At 410, the enclosure device negotiates a connection state on behalf of the audio device. The enclosure device engages in a bidirectional exchange of protocol frames with the electronic device to establish security parameters, session credentials, and cryptographic keys. The enclosure device executes this negotiation in parallel with the ongoing hardware boot sequence of the audio device. For example, the enclosure device communicates with the electronic device to generate a session key using a cross-transport key derivation (CTKD) process and secure a link-layer session, thereby finalizing the connection state over an air interface before the audio device finishes the boot sequence.

At 412, the enclosure device transfers connection state data to the audio device. The enclosure device extracts negotiated session keys, clock synchronization data, and protocol parameters from the connection state and passes this connection state data to the audio device via a physical contact interface or a short-range data link. Following the transfer of the connection state data, the enclosure device may disable an internal wireless transceiver to prevent an address collision between the enclosure device and the audio device. For example, the enclosure device transmits finalized session keys to the audio device, allowing the fully booted audio device to load the connection state data into an internal radio transceiver and accept an active media streaming link from the electronic device.

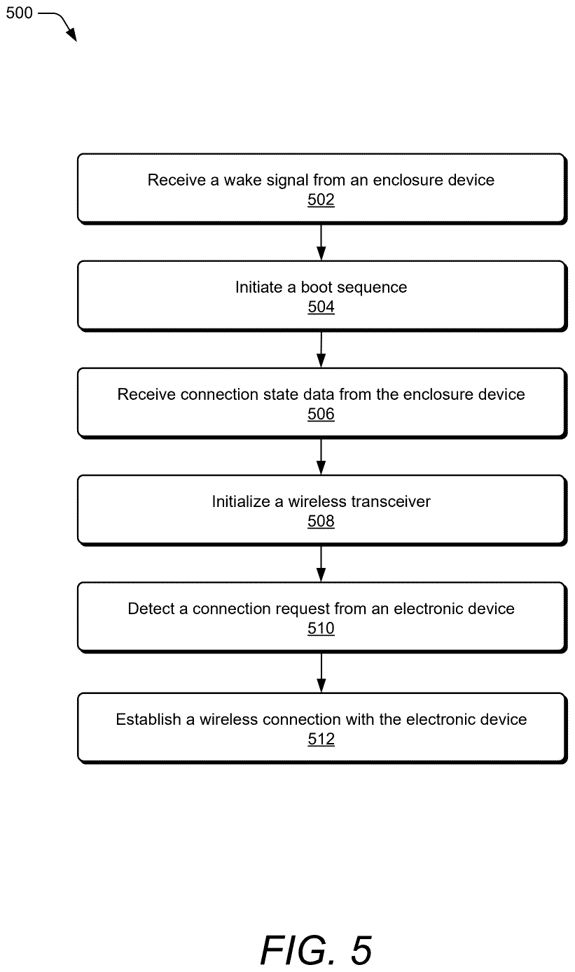

FIG. 5 illustrates an example method 500 for concurrent wireless protocol negotiation and audio device boot sequence in accordance with one or more aspects. Operations of the method 500 are implemented by or with earbuds 106.

Example method 500 is described with reference to FIG. 5 in accordance with one or more aspects of concurrent wireless protocol negotiation and audio device boot sequence. Generally, the method 500 illustrates sets of operations (or acts) performed in, but not necessarily limited to, the order or combinations in which the operations are shown herein. Further, any of one or more of the operations may be repeated, combined, reorganized, omitted, or linked to provide a variety of additional and/or alternate methods. In portions of the following discussion, reference may be made to the entities of FIG. 1-3, reference to which is made for example only. The systems and methods described in this disclosure are not limited to embodiment or performance by one entity or multiple entities operating in relation to concurrent wireless protocol negotiation and audio device boot sequence.

FIG. 5 illustrates an example method flowchart 500 performed by an audio device for concurrent wireless protocol negotiation and audio device boot sequence. The method flowchart 500 outlines a sequence of operations that an audio device executes to transition from a dormant state to an active media streaming state. By performing the operations of the method flowchart 500, the audio device uses proxy negotiations handled by an enclosure device to bypass communication delays and rapidly establish an active data link.

At 502, an audio device receives a wake-up signal from an enclosure device. The audio device receives the wake-up signal while residing in a low-power or powered-down state within a cavity of the enclosure device. The audio device detects the wake-up signal as an electrical or physical trigger through physical contacts, pins, or an inductive interface between the audio device and the enclosure device to initiate hardware activation. For example, upon a user opening a lid of the enclosure device, the audio device receives a direct voltage pulse from the enclosure device, signaling the audio device to exit a deep sleep mode.

At 504, the audio device initiates a boot sequence. In response to receiving the wake-up signal, the audio device begins a hardware and software initialization process. The audio device ramps up internal power rails, executes bootloader instructions, and copies execution code from a non-volatile flash memory into a random-access memory to prepare system processors for active computation. For example, the audio device loads an embedded operating system and audio processing firmware into active memory so that internal microcontrollers transition into a fully functional state capable of processing digital audio.

At 506, the audio device receives connection state data from the enclosure device. The audio device accepts data packets containing cryptographic credentials, session keys, or protocol parameters from the enclosure device. In some implementations, the audio device receives the connection state data prior to the completion of the boot sequence, using a parallel negotiation that the enclosure device conducted with an electronic device over a separate wireless channel. For example, while still initializing internal computing subsystems, the audio device receives a pre-negotiated link-layer session key through physical electrical contacts connected to the enclosure device, equipping the audio device with the credentials to securely join a wireless network.

At 508, the audio device initializes a wireless transceiver. As the boot sequence nears completion, the audio device supplies power to internal radio frequency hardware. The audio device applies the received connection state data to configure the wireless transceiver, placing the wireless transceiver into a targeted scanning or listening mode configured to recognize specific incoming communications. For example, the audio device turns on an internal high-bandwidth radio and configures the radio to enter a page scan state utilizing the exact timing and frequency parameters provided within the connection state data.

At 510, the audio device detects a connection request from an electronic device. The audio device monitors a wireless medium via the initialized wireless transceiver and registers an incoming transmission directed to a specific hardware address of the audio device. Because the enclosure device previously prompted the electronic device during the concurrent boot phase, the audio device detects the connection request upon activating the wireless transceiver. For example, the audio device captures an active page request broadcast by a smartphone acting as the electronic device, recognizing the connection request based on synchronization data previously supplied by the enclosure device.

At 512, the audio device establishes a wireless connection with the electronic device. The audio device responds to the connection request and finalizes a high-bandwidth data link with the electronic device using the pre-negotiated connection state data. The audio device transitions into an active streaming profile capable of receiving media payloads and transmitting voice data over the wireless connection. For example, the audio device completes an advanced audio distribution profile handshake with the smartphone, allowing a user to hear music streaming through the audio device as the user places the audio device into an ear.

As an alternative to sharing a single Media Access Control (MAC) address, the enclosure device and the audio device may utilize an Identity Resolving Key (IRK) to manage network identification. In this configuration, the enclosure device and the audio device possess distinct MAC addresses but share a common IRK provisioned during factory setup or initial pairing. When the enclosure device proxies the connection state negotiation, the electronic device uses the IRK to resolve the separate addresses. This enables the electronic device to treat both components as distinct interfaces of the same logical audio system, thereby preventing address collisions and facilitating a handover without the enclosure device executing a radio shutdown protocol.

### Conclusion

Although aspects of concurrent wireless protocol negotiation and audio device boot sequence have been described in language specific to features and/or methods, the subject of the appended claims is, as recited by any of the previous examples, not necessarily limited to the specific features or methods described. Rather, the specific features and methods are disclosed as example implementations of concurrent wireless protocol negotiation and audio device boot sequence, and other equivalent features and methods are intended to be within the scope of the appended claims. Further, various aspects of concurrent wireless protocol negotiation and audio device boot sequence are described, and it is to be appreciated that each described aspect may be implemented independently or in connection with one or more other described aspects.

What is claimed is:

1. A method performed by an enclosure device of an audio device, the enclosure device having a lid and a sensor, the method comprising:
detecting, via the sensor, a trigger event, the trigger event comprising an opening of the lid;
transmitting, from the enclosure device to the audio device and in response to the trigger event, a wake-up signal configured to initiate a boot sequence of the audio device;
negotiating, by the enclosure device with an electronic device, a connection state on behalf of the audio device; and
transferring, from the enclosure device to the audio device, connection state data associated with the negotiated connection state, the connection state data enabling the audio device to establish a wireless connection with the electronic device.

2. The method of claim 1, wherein the negotiating occurs at least partially concurrently with the boot sequence of the audio device.

3. The method of claim 1, further comprising:
transmitting, from the enclosure device to the electronic device, a first communication comprising an identifier associated with the audio device.

4. The method of claim 3, wherein the identifier associated with the audio device comprises a media access control (MAC) address of the audio device.

5. The method of claim 1, wherein negotiating the connection state comprises generating a session key using a cross-transport key derivation (CTKD) process, and wherein the connection state data comprises the session key.

6. The method of claim 1, wherein transferring the connection state data from the enclosure device to the audio device comprises transmitting the connection state data via at least one of a physical contact of the enclosure device or a wireless communication link.

7. The method of claim 1, further comprising:
operating a processor of the enclosure device in a low-power mode prior to detecting the trigger event; and
executing, in response to detecting the trigger event, instructions directly from a memory of the enclosure device in an execute-in-place mode without copying the instructions to a random-access memory (RAM) of the enclosure device.

8. The method of claim 1, wherein the wake-up signal is configured to cause the audio device to initiate the boot sequence by ramping a power rail of the audio device and copying execution code from a memory of the audio device to a random-access memory (RAM) of the audio device.

9. The method of claim 1, further comprising:
disabling a wireless transceiver of the enclosure device subsequent to transferring the connection state data to prevent an address collision between the enclosure device and the audio device.

10. The method according to claim 1, wherein the enclosure device comprises a charging case for enclosing the audio device, wherein opening the lid provides access to the audio device, and wherein the charging case includes a short range radio frequency transceiver activated to communicate with the electronic device responsive to the trigger event.
